(19) United States
(12) Patent Application Publication
(10) Pub. No.: US 2015/0336310 A1
(43) Pub. Date: Nov. 26, 2015

(54) System and Method for Molding Multi-Layer Plastic Item Using Multiple Mold Cores

(71) Applicant: Silgan Plastics LLC, Chesterfield, MO (US)

(72) Inventor: Randal Porter, Norcross, GA (US)

(21) Appl. No.: 14/819,177

(22) Filed: Aug. 5, 2015

Related U.S. Application Data
(63) Continuation of application No. PCT/US2015/024023, filed on Apr. 2, 2015.
(60) Provisional application No. 61/976,299, filed on Apr. 7, 2014.

(51) Int. Cl. B29C 45/00; B32B 27/36; B32B 27/08; B32B 1/02

(52) U.S. Cl. CPC B29C 45/0003; B32B 1/02; B32B 27/36; B32B 27/08; B29K 2067/003

(57) ABSTRACT

A method and system of injection molding a plastic item, such as a preform, is provided. The method and system relates to positioning a first core within a mold cavity such that a first space is defined between the inner surface of the mold cavity and the outer surface of the first core and injecting a flowable first plastic material into the first space to form a first preform layer. The method and system relate to positioning a second core within the mold cavity and within the first preform layer such that a second space is defined between the inner surface of the first preform layer and the outer surface of the second core and injecting a flowable second plastic material into the second space to form a second preform layer located inside the first preform layer.

### CROSS-REFERENCE TO RELATED PATENT APPLICATION

This application is a continuation of International Patent Application No. PCT/US2015/024023, filed Apr. 2, 2015, which claims priority to and the benefit of U.S. Provisional Patent Application No. 61/976,299, filed Apr. 7, 2014, which are incorporated herein by reference in their entireties.

### BACKGROUND OF THE INVENTION

The present invention relates generally to the field of plastic molding. The present invention relates specifically to a system and method of molding a plastic item using more than one mold core during molding.

Many commercial plastic containers are formed by blow-molding a plastic preform within a mold to form a plastic container of the desired size and shape. Typically, the preform is heated to a temperature that allows the material of the plastic to soften, and air is blown into the center of the preform causing the preform to expand into confluence with the cavity of the blow mold. In many conventional systems, the preform used during blow molding is formed by injection molding a single layer of plastic for create the preform. In other conventional systems, a multilayer preform is injection molded using an overmolding process. In the overmolding processes, the preform is formed by injection molding a first layer of plastic around a single mold core. Next, while leaving the single mold core in place, a second layer of plastic is injection molded around the outside of the first layer of plastic. Such systems are typically referred to as over-molding systems because each subsequent injection molded layer is deposited along the outer surface of a preceding layer in the molding process.

### SUMMARY OF THE INVENTION

One embodiment of the invention relates to a method of injection molding a plastic preform. The method includes providing an injection mold system including an inner surface defining an injection mold cavity. The method includes positioning a first core having an outer surface within the injection mold cavity such that a first space is defined between the inner surface of the injection mold cavity and the outer surface of the first core. The method includes injecting a flowable first plastic material into the first space to form a first preform layer having an outer surface facing the inner surface of the injection mold cavity and an inner surface facing the first core. The method includes solidifying the first preform layer. The method includes removing the first core from the injection mold cavity such that the inner surface of the first perform layer defines a first preform cavity. The method includes positioning a second core having an outer surface within the injection mold cavity and within the first preform cavity such that a second space is defined between the inner surface of the first preform layer and the outer surface of the second core. The method includes injecting a flowable second plastic material into the second space to form a second preform layer having an outer surface contacting the inner surface of the first preform layer and an inner surface facing the second core.

Another embodiment of the invention relates to an injection molding system. The injection molding system includes a mold body having an open end, a closed end and an inner surface defining a mold cavity shaped to form a plastic item. The injection molding system includes a gate extending through the closed end of the mold body. The injection molding system includes a resin injection system coupled to the gate. The gate is moveable between a closed position and an open position in which resin is delivered from the resin injection system through the gate into the mold cavity. The injection molding system includes a first mold core including an outer surface. The injection molding system includes a second mold core including an outer surface. An outer dimension of the outer surface of the first mold core is greater than an outer dimension of the outer surface of the second mold core. The injection molding system includes an actuator configured to move the first mold core into the mold cavity, to remove the first mold core from the mold cavity and to move the second mold core into the mold cavity after removal of the first mold core.

Another embodiment of the invention relates to an injection molded preform. The preform includes an outer layer formed from a first plastic material. The outer layer has an inner surface and an outer surface that defines an exterior sidewall surface of the preform. The preform includes a hole formed in the outer layer extending from the outer surface of the outer layer to the inner surface of the outer layer. The preform includes an inner layer formed from a second plastic material. The inner layer has an inner surface defining an inner surface of the preform and an outer surface. A portion of the inner layer extends through the hole. The second plastic material is a light transmitting material, and the first plastic material is more opaque than the second plastic material.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a diagram showing an injection molding system according to an exemplary embodiment.

FIG. 2 is a cross-sectional view showing formation of an outer layer of a preform using the system of FIG. 1 according to an exemplary embodiment.

FIG. 3 is a cross-sectional view showing formation of an inner layer of a preform using the system of FIG. 1 according to an exemplary embodiment.

FIG. 4 is a perspective view of a preform including at least one window section according to an exemplary embodiment.

FIG. 5 is a cross-sectional view of the preform of FIG. 4 according an exemplary embodiment.

### DETAILED DESCRIPTION

Referring generally to the figures, various embodiments of a system and method for forming a multilayer blow-mold preform are shown and described. In other embodiments, the multi-core system described herein may be used for the molding of other plastic items, e.g., vials, thick-walled bottles, tubes, etc. In specific embodiments, the multi-layer plastic components and/or multi-layer plastic preforms discussed herein are molded using a system and process that molds the outermost layer of the preform first and forms each subsequent layer inside of the adjacent outer layer. In specific embodiments, the system and method discussed herein utilize multiple mold cores of differing diameters during preform molding.

To form the first, outermost component or preform layer, a first mold core is positioned in the cavity of the injection mold body, and the resin material of the first preform layer is injected into the space between the outer surface of the first mold core and the mold cavity. Once the resin material of the first layer cools and solidifies, the first mold core is removed from the injection mold cavity. Next, a second mold core that is smaller than the first mold core is positioned within the injection mold cavity and also within the first preform layer. In this position, the resin material of the second preform layer is injected into the space between the outer surface of the second mold core and the inner surface of the first preform layer. Once the material of the second preform layer solidifies, the second mold core is removed and the finished preform is removed from the injection mold.

Thus, the system and process discussed herein forms a multi-layer preform by forming each layer of the preform inside of an outer preform layer. In contrast to conventional overmolding processes, the process described herein allows each layer of the preform to be molded while in direct contact with a mold core. This arrangement is believed to allow each preform layer to be cooled more quickly due to contact with the mold core, in comparison to overmolding techniques where each subsequent layer has a layer of plastic between the newly injected layer and the mold core. Allowing for fast cooling may be advantageous for a variety of reasons including limiting crystallization that is common with PET resin that is cooled slowly. Further it is believed that the system and process discussed herein allows for the formation of preforms having a thicker sidewall with better and more precisely controlled material properties than other conventional preform injection molding systems, such as overmolding systems.

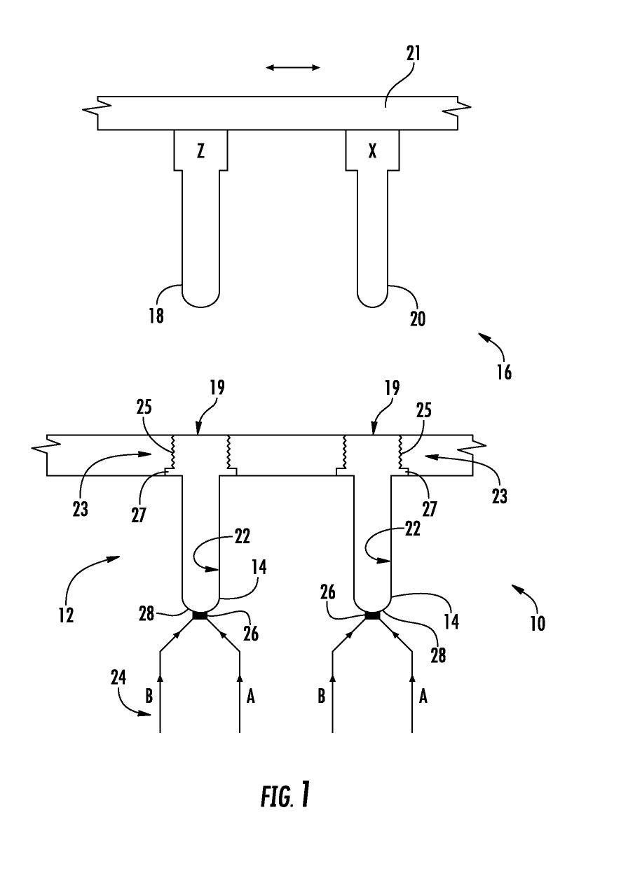

Referring to FIG. 1, an injection mold system 10 configured to produce a multilayer plastic item, such as a blow-mold preform, is shown according to an exemplary embodiment. Generally, injection mold system 10 includes a mold body 12 that includes a plurality of mold cavities 14. System 10 includes a mold core assembly, generally shown as core insert assembly 16. In general, core insert assembly 16 includes multiple larger mold cores 18 and multiple smaller mold cores 20. In such embodiments, larger mold cores 18 have an outer surface having an outer dimension that is greater than an outer dimension of the outer surface of smaller mold cores 20. In the embodiment shown in FIG. 1, each mold core 18 and each mold core 20 have an outer surface that includes a cylindrical portion, and in such embodiments, the diameter of the cylindrical outer surface of mold core 18 is greater than the diameter of the cylindrical outer surface of mold core 20.

System 10 also includes an actuator, shown as mold core actuator 21. Mold core actuator 21 is an actuation device configured to or operable to move mold cores 18 and 20 into and out of mold cavities 14. Mold core actuator 21 is also configured to index mold cores 18 and 20 relative to mold cavities 14 to alternately position mold core 20 into each cavity 14 following removal of mold core 18 into a given cavity to form the two layer perform discussed below. In the embodiment shown, each mold cavity 14 includes an open end 19, and mold core actuator 21 is configured to move mold cores 18 and 20 into and out of mold cavities 14 through open end 19 via operation of mold core actuator 21.

Each mold cavity 14 includes an inner surface 22 that is shaped to create the contours of the outer surface of the preform, and, as will be explained in more detail below, the outer surface of smaller diameter mold cores 20 are shaped to create the contours of the inner surface of the preform formed using injection mold system 10. In some embodiments configured for formation of a blow-mold preform (i.e., a preform intended for use during blow molding to form a blow molded container), inner surface 22 includes an upper portion 23 with contours shaped to form threading 25 and a collar 27 on the outer surface of the molded preform. Injection mold system 10 utilizing mold cavity 14 and mold cores 18 and 20 allows for a preform to be formed with precisely controlled inner and outer diameters, and also allows for a preform having multiple layers and may also allows for formation of preforms that are thicker and/or have superior material properties than preforms formed using overmolding or other conventional molding systems.

Injection mold system 10 includes a resin injection system 24 that is in fluid communication with cavity 14 such that liquid resin is permitted to flow into mold cavity 14 to produce a preform. In one embodiment, resin injection system 24 includes a gate 26 located through the closed end 28 of each mold cavity 14. In general, gate 26 is a mechanical structure that selectively opens and closes to control flow of liquid resin from resin injection system 24 to mold cavity 14. In another embodiment, resin injection system 24 may be a thermal gated system in which the opening into the injection mold cavity remains open and flow of liquid resin into mold cavity 14 is controlled by controlling the temperature and/or pressure of the liquid resin within resin injection system 24.

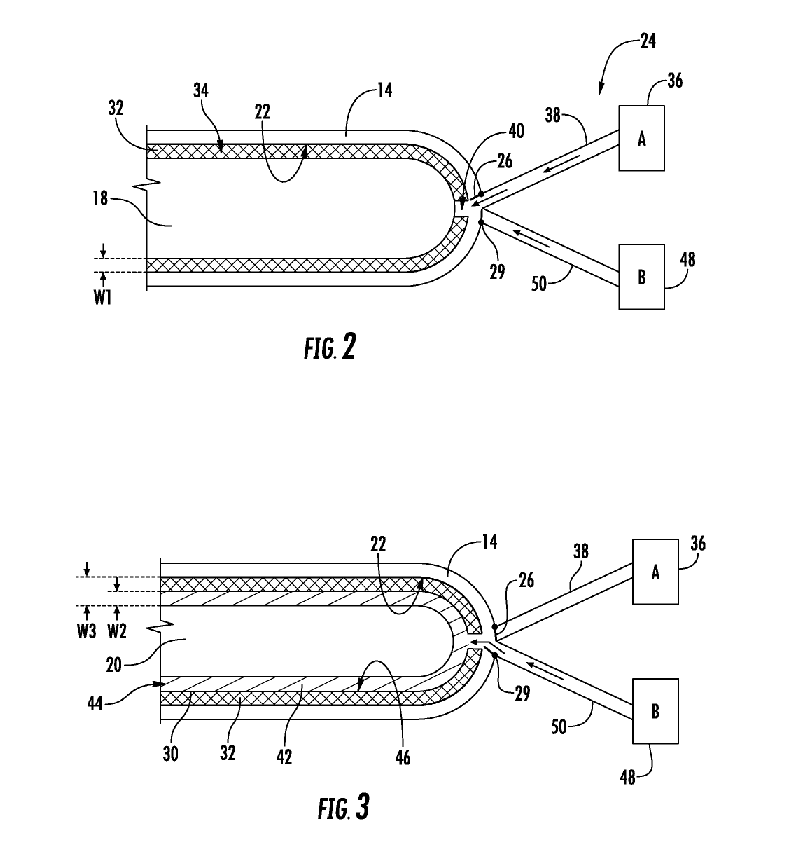

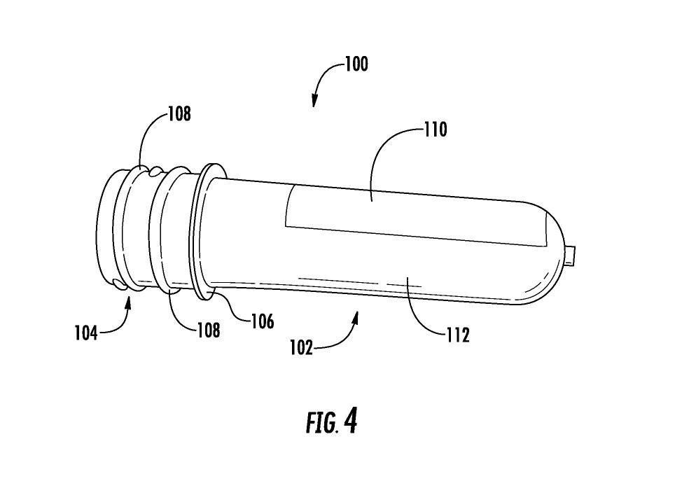

Referring to FIG. 2 and FIG. 3, formation of a multilayer preform, shown as preform 30, utilizing injection mold system 10 is shown according to an exemplary embodiment. Referring specifically to FIG. 2, the molding of a first preform layer, shown as outer layer 32, is shown according to an exemplary embodiment. To form outer layer 32, larger diameter mold core 18 is located within mold cavity 14 such that a space 34 is defined between inner surface 22 of mold cavity 14 and the outer surface of mold core 18, and this space has a width W1 that corresponds to the thickness of outer layer 32 following injection molding.

To form outer layer 32, gate 26 opens allowing resin injection system 24 to inject a flowable first plastic material, shown as molten resin A, into the space 34. With gate 26 is the first open position shown in FIG. 2, a fluid path is defined through from supply 36 of resin A, through conduit 38, through gate 26 and into space 34. The fluid path allows the flowable resin A to be delivered from supply 36 into space 34. After a sufficient amount of resin A has been delivered to fill space 34, resin A within space 34 is allowed to solidify, typically by cooling, to form a solid outer layer 32.

Outer layer 32 includes a channel 40 extending through outer layer 32 that provides a passageway for a second resin material to be delivered to the interior surface of outer layer 32. In one embodiment, a cylindrical wall is located or inserted into flowable material of outer layer 32 prior to solidification that acts to block the area for channel 40, and following solidification, the cylindrical wall is removed leaving channel 40. In another embodiment, channel 40 is formed following solidification of the material of outer layer 32, for example via mechanical or laser drilling.

Referring specifically to FIG. 3, the molding of a second preform layer, shown as inner layer 42, is shown according to an exemplary embodiment. To form inner layer 42, smaller diameter mold core 20 is located within mold cavity 14 and within a cavity defined by the inner surface of outer layer 32 such that a space 44 is defined between inner surface 46 of outer layer 32 and the outer surface of mold core 20, and this space has a width W2 that corresponds to the thickness of inner layer 42 following injection molding.

To form inner layer 42, gate 29 opens allowing resin injection system 24 to inject a flowable second plastic material, shown as molten resin B, into the space 44. With gate 29 is the second open position shown in FIG. 3, a fluid path is defined from supply 48 of resin B, through conduit 50, through gate 29, through channel 40 through outer layer 32 and into space 44. The fluid path allows the flowable resin B to be delivered from supply 48 into space 44. After a sufficient amount of resin B has been delivered to fill space 44, resin B within space 44 is allowed to solidify, typically by cooling, to form a solid inner layer 42. In a two layer version of preform 30, mold core 20 is removed and preform 30 is removed or ejected from the mold. In various embodiments, preform 30 may include more than two layers, with each subsequent inner layer being applied by inserting a mold core with an incrementally smaller outer diameter to form the next inner layer.

Referring back to FIG. 1, in various embodiments injection molding system 10 includes multiple mold cavities and multiple mold cores. In such embodiments, core insert assembly 16 is indexed such that smaller diameter mold core 20 is aligned with the mold core containing outer layer 32 following the formation of an outer layer 32 within each mold cavity of molding system 10, and then mold core 20 is inserted into mold cavity 14. With mold core 20 within each cavity 14 including outer layer 32, inner layer 42 is formed as discussed above. In various embodiments, such an arrangement allows for multiple preforms (e.g., 10, 20, 30, 40, etc.) to formed in each cycle of injection molding system 10.

As can be seen in FIG. 2 and FIG. 3, the configuration of injection molding system 10 is such that as each new preform layer is injection molded, the inner surface of the newly formed layer of the preform is in contact with the outer surface of the corresponding mold core. In this arrangement, each mold core facilitates cooling of the injected resin material by conducting heat away from the resin material. Facilitating accelerated cooling of the injected resin material may be advantageous for certain applications and/or for certain resin types. For example in one embodiment, resin A and/or resin B are PET resin materials that partially crystallize resulting in a cloudy appearance noticeable in the final blow-molded container if the materials are allowed to cool to slowly. Thus, because the ability to transfer heat from the molded preform layer is related to the thickness of the layer, mold system 10 provides for molding thick-walled preforms while allowing for fast cooling by molding the preform in stages such that the flowable or molten resin material is in contact with the mold core.

In some embodiments, mold cores 18 and 20 act as passive cooling elements or heat-sinks that remove heat through conduction without active cooling systems, and in such embodiments, mold cores 18 and 20 are formed from a material with high thermal conductivity (e.g., metal). In other embodiments, mold cores 18 and 20 are actively cooled. In one such embodiment, mold cores 18 and 20 have a cooling circuit, such as internal conduits that circulate a cooling fluid that decreases the temperature of the outer surfaces of mold cores 18 and 20 and that provides a means for transferring heat from the injected preform layer. In various embodiments, the cooling device or circuit for mold cores 18 and 20 are configured maintain a mold core surface temperature below 200 degrees Fahrenheit, specifically to between 0 degrees Fahrenheit and 200 degrees Fahrenheit, and more specifically to between 0 degrees Fahrenheit and 100 degrees Fahrenheit.

In addition to forming multilayer preforms with improved cooling characteristics, injection molding system 10 may be used to form a preform with thicker sidewalls than other conventional molding methods. Referring to FIG. 2 and FIG. 3, outer layer 32 has a thickness that corresponds to W1, inner layer 42 has a thickness that corresponds to W2, and preform 30 has a total wall thickness shown as W3. As shown, W3 results from the combined thickness of each layer of the preform, and in the embodiment of FIG. 3, W3 results from the combined thicknesses W1 and W2. In various embodiments, both W1 and W2 are equal to or greater than 0.1 inches, and in one such embodiment, W1 and W2 are substantially equal to each other (e.g., within manufacturing tolerances of each other, within plus or minus 0.001 inches of each other, etc.). In various embodiments, both W1 and W2 are between 0.1 and 0.2 inches, and in one such embodiment, W1 and W2 are substantially equal to each other (e.g., within manufacturing tolerances of each other, within plus or minus 0.001 inches of each other, etc.). In another embodiment, W3 is equal to or greater than 0.2 inches. As will be understood, W1, W2 and W3 are formed resulting from the distances between the outer surfaces of mold cores 18 and 20 and the inner surface of mold cavity 14. In various embodiments, the distance between the cylindrical outer surface of first mold core 18 and the inner surface of the mold cavity 14 is between 0.1 and 0.2 inches and the distance between the cylindrical outer surface of second mold core 20 and the inner surface of the mold cavity 14 is between 0.2 and 0.4 inches. As noted above, injection molding system 10 through the inner molding process and the related cooling provides for preforms of greater thicknesses while also limiting or preventing problems that may be associated with limited cooling common with processes such as overmolding.

Injection molding system 10 may be used to form preforms from a wide variety of plastics, including plastic resins used for the formation of containers. In various embodiments, the layers of preform 30 may be formed from various resin types including polyethylene, polypropylene, or polyethylene terephthalate. In various embodiments, each layer of preform 30 may be formed from the same resin type, and in other embodiments, each layer of preform 30 may be formed from a different resin type. In various embodiments, preform 30 may include more than two layers, and in certain such embodiments, preform 30 may include one or more barrier material layer (e.g., an ethylene vinyl alcohol (“EVOH”) layer, a nylon layer, etc.).

In various embodiments, each layer of preform 30 may be the same or different resin types with different properties or additives. For example in one embodiment, resin A of outer layer 32 includes a coloring additive lending a desired color to preform 30 and to the final blow-molded container formed from preform 30. In various embodiments in which outer layer 32 includes a colorant material, resin B of inner layer 42 is a plastic resin material without a coloring additive, and in another such embodiment, resin B of inner layer 42 is an approved food contacting plastic material, such as a virgin plastic resin material. In such embodiments, resin B of inner layer 42 is a plastic resin having a contaminant level (e.g., a level of unknown material, non-resin materials, toxins, heavy metals, etc.) that is a below a threshold such that the material has been deemed safe as a food contacting surface.

In some embodiments in which outer layer 32 includes a colorant material, resin B of inner layer 42 is a translucent plastic resin material (i.e., a material that transmits visual spectrum light, including transparent materials). In another embodiment, resin A may include a post-consumer recycled resin material, and resin B is an approved food contacting plastic material, such as a virgin plastic resin material. In another embodiment, resin A may include UV blocking additive materials, and resin B is a resin material without UV blocking additive materials. In such embodiments, the use of a resin B that is an approved food contacting resin allows outer layer 32 to be formed from a material without needing to ensure that each material for outer layer 32 is food contact compatible.

It should be understood that while the exemplary embodiments discussed herein relate primarily to system 10 configured to form a two-layer preform for use in the formation of a blow-molded container, in other embodiments, system 10 is configured to form plastic items or preforms with more than two layers (e.g., 3 layers, 4 layers, 5 layers, etc.). In such embodiments, injection molding system 10 includes a mold core assembly having a mold core of progressively smaller diameters to form each layer.

In various embodiments, a method of forming a multi-layer molded plastic item, such as a preform, is provided herein. In various embodiments, the method may utilize or operate system 10 discussed above. The method includes providing an injection mold system including an inner surface defining an injection mold cavity. The method includes positioning a first core having an outer surface within the injection mold cavity such that a first space is defined between the inner surface of the injection mold cavity and the outer surface of the first core. The method includes injecting a flowable first plastic material into the first space to form a first preform layer having an outer surface facing the inner surface of the injection mold cavity and an inner surface facing the first core. The method includes solidifying the first preform layer. The method includes removing the first core from the injection mold cavity such that the inner surface of the first perform layer defines a first preform cavity. The method includes positioning a second core having an outer surface within the injection mold cavity and within the first preform cavity such that a second space is defined between the inner surface of the first preform layer and the outer surface of the second core. The method includes injecting a flowable second plastic material into the second space to form a second preform layer having an outer surface contacting the inner surface of the first preform layer and an inner surface facing the second core.

In various embodiments, the method includes or utilizes one or more of the components of system 10 as discussed herein. In various embodiments, the method includes forming a channel through the first preform layer, and the flowable second plastic material is injected through the channel into the second space to form the second preform layer. In various embodiments, the method includes providing a supply of the first plastic material in fluid communication with the injection mold cavity and providing a supply of the second plastic material in fluid communication with the injection mold cavity. In various embodiments, the method includes moving a gate to a first position in which the flowable first plastic material flows from the supply of the first plastic material, through the gate and into the first space and moving the gate to a second position following removing of the first core and following positioning of the second core. In such embodiments, the gate in the second position allows the flowable second plastic material to flow from the supply of the second plastic material, through the gate, through the channel and into the second space.

In various embodiments, a preform and a container having a transparent portion or widow are provided. In such embodiments, the window provides for viewing of the interior cavity and/or contents of a container through the window. In additional embodiments, systems and methods for forming a preform and container having a transparent portion are provided.

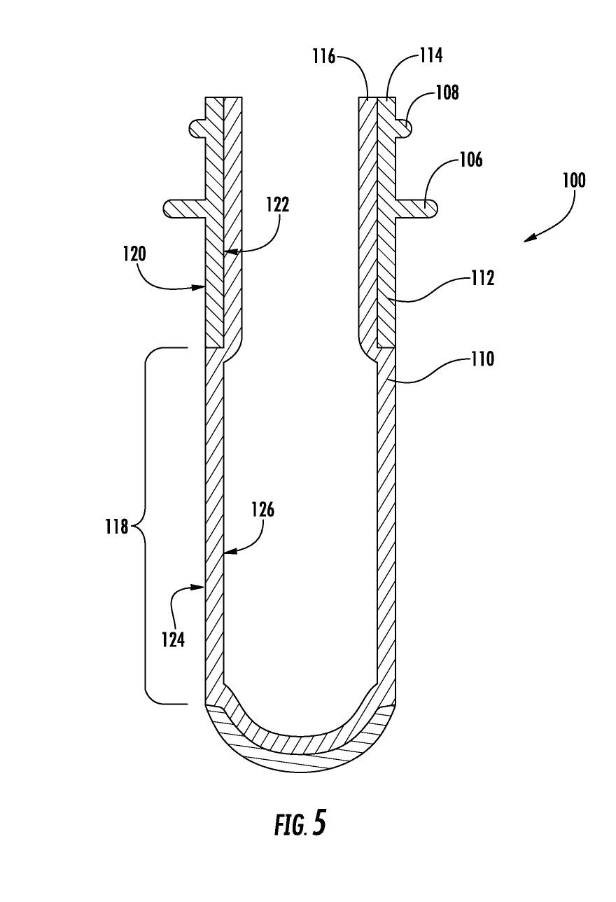

Referring to FIG. 4, a preform 100 is shown according to an exemplary embodiment. Preform 100 includes a body portion 102, a neck portion 104, and a collar 106 located between body portion 102 and neck portion 104. In general, body portion 102 is the portion that becomes the container body following blow molding, and neck portion 104 becomes the neck of the container. As shown, neck portion 104 includes a closure engagement structure, shown as threads 108, that acts to engage cooperating structures of a closure to seal the container. In other embodiments, preform 100 may include any suitable closure engaging structure including one or more snap bead, retaining lug, child-proof structures, etc.

Body 102 of preform 100 includes a light transmitting (e.g., transparent, translucent) window portion 110 and includes a more opaque body portion 112 surrounding window portion 110. In various embodiments, window portion 110 is made from a material that is less opaque than surrounding body portion 112. Thus, in some embodiments, body portion 112 may not be completely opaque. However in other embodiments, surrounding body portion 112 may be completely opaque. In various embodiments, both window portion 110 and surrounding body portion 112 are made from the same type of resin (e.g., both are PET) but include different fillers/additives resulting in the different light transmitting properties. In other embodiments, window portion 110 and surrounding body portion 112 may be made from different types of resin. Following formation of a bottle or container from preform 100, the container includes a window formed from the material of preform window portion 110. A window in an otherwise opaque container may be desirable to allow a user to view the amount of contents in the container while still providing substantial protection to the container contents from light.

Referring to FIG. 5, a cross-sectional view of preform 100 is shown according to an exemplary embodiment. As shown in FIG. 5, preform 100 is formed from two injection molded layers, an outer layer 114 and an inner layer 116. In various embodiments, an injection molding system, such as system 10 above, is used to injection mold the layers of preform 100. In such an embodiment, outer layer 114 is injection molded within a mold cavity using a first, large diameter mold core, such as mold core 18 discussed above. In such embodiments, the large diameter mold core is configured such that one or more gap or hole 118 is formed through outer layer 114. In such embodiments, the mold may be a multi-piece mold in which the large diameter mold core used to form outer layer 114 is configured to be removed from the mold following formation of outer layer 114. In another embodiment, outer layer 114 may be injected molded as a complete layer without hole 118 formed through the layer, and hole 118 is formed via cutting and removal of material from outer layer 114. In either embodiment, hole 118 extends through outer layer 114 from an outer surface 120 of outer layer 114 to an inner surface 122 of outer layer 114.

Following removal of the large diameter mold core, a small diameter mold core, such as mold core 20, is placed into outer layer 114, and inner layer 116 is injection molded along the inner surface of outer layer 114 as discussed above. In this embodiment, inner layer 116 is made from a light transmitting material such that the portion of inner layer 116 that fills in hole 118 acts as a window allowing material within the final blow molded container to be viewed through the wall of the container. Thus, at the position of hole 118, inner layer 116 forms both an exterior surface of preform 100, shown as outer surface 124, and an inner surface 126 of preform 100. In certain embodiments, the resin material of inner layer 116 is both translucent and food-contact compatible.

In one embodiment as shown in FIG. 5, inner layer 116 may have a substantially constant thickness along the inner surface of the sidewall of outer layer 114. Thus, in this embodiment the wall of preform 100 at window 110 has a lower thickness than the adjacent portions of the sidewall of preform 100. In another embodiment, inner layer 116 may be formed such that the inner diameter of inner layer 116 is substantially constant along the length of the sidewall, and in this embodiment, the thickness of inner layer 116 increases at the position of window 110 such that both the outer diameter and the inner diameter of preform 100 at window 110 is substantially constant.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. Other substitutions, modifications, changes and omissions may also be made in the design, operating conditions and arrangement of the various exemplary embodiments without departing from the scope of the present invention.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above in the implementation of the teachings of the present disclosure.

What is claimed is:

1. A method of injection molding a plastic preform comprising:
providing an injection mold system including an inner surface defining an injection mold cavity;
positioning a first core having an outer surface within the injection mold cavity such that a first space is defined between the inner surface of the injection mold cavity and the outer surface of the first core;
injecting a flowable first plastic material into the first space to form a first preform layer having an outer surface facing the inner surface of the injection mold cavity and an inner surface facing the first core;
solidifying the first preform layer;
removing the first core from the injection mold cavity such that the inner surface of the first perform layer defines a first preform cavity;
positioning a second core having an outer surface within the injection mold cavity and within the first preform cavity such that a second space is defined between the inner surface of the first preform layer and the outer surface of the second core; and
injecting a flowable second plastic material into the second space to form a second preform layer having an outer surface contacting the inner surface of the first preform layer and an inner surface facing the second core.

2. The method of claim 1 wherein a diameter at a midpoint along a length of the second core is less than a diameter at a midpoint along a length of the first core.

3. The method of claim 1 further comprising forming a channel through the first preform layer, wherein the flowable second plastic material is injected through the channel into the second space to form the second preform layer.

4. The method of claim 3 wherein the injection mold cavity includes an open end, and a closed end, wherein the injection mold system includes a gate located at the closed end of the injection mold cavity, the gate is moveable between a closed position and an open position in which resin is injected through the gate into the injection mold cavity.

5. The method of claim 4 further comprising:
providing a supply of the first plastic material in fluid communication with the injection mold cavity;
providing a supply of the second plastic material in fluid communication with the injection mold cavity;
moving the gate to a first position in which the flowable first plastic material flows from the supply of the first plastic material, through the gate and into the first space; and
moving the gate to a second position following removing of the first core and following positioning of the second core, wherein the gate in the second position allows the flowable second plastic material to flow from the supply of the second plastic material, through the gate, through the channel and into the second space.

6. The method of claim 1 wherein the first plastic material and the second plastic material are PET.

7. The method of claim 1 wherein the first plastic material includes an additive material.

8. The method of claim 7 wherein the additive is a colorant material and wherein the second plastic material is an approved food contacting material.

9. The method of claim 8 wherein the second plastic material is a translucent plastic material.

10. The method of claim 1 wherein the first core includes a first cooling circuit carrying a cooling fluid to cool the outer surface of the first core and the first preform layer, wherein the first preform layer is solidified by cooling.

11. The method of claim 10 further comprising solidifying the second preform layer, wherein the second core includes a second cooling circuit carrying a cooling fluid to cool the outer surface of the second core and the second preform layer, wherein the second preform layer is solidified by cooling.

12. The method of claim 1 wherein the first preform layer is greater than 0.1 inches thick and the second preform layer is greater than 0.1 inches thick.

13. The method of claim 1 wherein the combined thickness of the first preform layer and the second preform layer is greater than 0.2 inches thick.

14. The method of claim 1 wherein the first preform layer includes a gap located within the first preform layer and the gap provides an opening extending between the outer surface and the inner surface of the first preform layer, wherein a portion of the second preform layer extends through the gap such that the second preform layer defines both the outer surface and the inner surface of the preform at the position of the gap.

15. The method of claim 14 wherein the first plastic material is more opaque then the second plastic material such that the second preform layer forms a window located within the gap in the first preform layer.

16. An injection molding system comprising:
a mold body having an open end, a closed end and an inner surface defining a mold cavity shaped to form a plastic item;
a gate extending through the closed end of the mold body;
a resin injection system coupled to the gate, wherein the gate is moveable between a closed position and an open position in which resin is delivered from the resin injection system through the gate into the mold cavity;
a first mold core including an outer surface;
a second mold core including an outer surface, wherein an outer dimension of the outer surface of the first mold core is greater than an outer dimension of the outer surface of the second mold core; and
an actuator operable to move the first mold core into the mold cavity, to remove the first mold core from the mold cavity, and to move the second mold core into the mold cavity after removal of the first mold core.

17. The injection molding system of claim 16 further comprising:
a first resin source containing a first resin material in fluid communication with the mold cavity; and
a second resin source containing a second resin material in fluid communication with the mold cavity;
wherein the outer surfaces of the first mold core and the second mold core are cylindrical outer surfaces and the outer dimension of the outer surfaces of the first mold core and the second mold core are outer diameters of the cylindrical outer surfaces.

18. The injection molding system of claim 17 wherein the first resin material is PET and the second resin material is PET.

19. The injection molding system of claim 17 wherein the first resin material includes a colorant and the second resin material is an approved food contacting material.

20. The injection molding system of claim 16 wherein a distance between the outer surface of the first mold core and the inner surface of the mold body is between 0.1 and 0.2 inches, wherein a distance between the outer surface of the second mold core and the inner surface of the mold body is between 0.2 and 0.4 inches.

21. The injection molding system of claim 16 further comprising a cooling circuit configured to deliver cooling fluid to the first core and the second core.

22. The injection molding system of claim 21 wherein the cooling circuit cools the outer surface of the first core and the outer surface of the second core to below 100 degrees Fahrenheit.

23. An injection molded preform comprising:
an outer layer formed from a first plastic material, the outer layer having an inner surface and an outer surface that defines an exterior sidewall surface of the preform;
a hole formed in the outer layer extending from the outer surface of the outer layer to the inner surface of the outer layer; and
an inner layer formed from a second plastic material, the inner layer having an inner surface defining an inner surface of the preform and an outer surface, wherein a portion of the inner layer extends through the hole;
wherein the second plastic material is a light transmitting material and the first plastic material is more opaque than the second plastic material.

24. The preform of claim 23 wherein both the first plastic material and the second plastic material are PET.
